(19) United States
(12) Patent Application Publication
(10) Pub. No.: US 2002/0106093 A1
(43) Pub. Date: Aug. 8, 2002

(54) Digital loudspeaker

(76) Inventors: Farad Azima, London (GB); Artemis Azima, London (GB)

Correspondence Address: Alan I. Cantor, FOLEY & LARDNER, Washington Harbour, 3000 K Street, N.W., Suite 500, Washington, DC, 20007-5109, US

(21) Appl. No.: 09/764,136

(22) Filed: Jan. 19, 2001

Related U.S. Application Data
(63) Continuation of application No. PCT/GB99/02316, filed on Jul. 19, 1999.

(30) Foreign Application Priority Data
Jul. 21, 1998 (GB) 9815728.2
Aug. 5, 1998 (GB) 9816975.8

(51) Int. Cl. H04R 3/00; H04B 1/02

(52) U.S. Cl. 381/111; 700/94; 367/153; 367/138

(57) ABSTRACT

A loudspeaker system has a plurality of loudspeaker elements (23), and a transmitter (33) for transmitting information in the form of a beam (34) to the loudspeaker elements. The information may be transmitted in parallel to each element. A selection means (31) is provided so that sound is only reproduced by the intended loudspeaker element or elements. The information is transmitted in digital form.

This application is a continuation of PCT/GB99/02316, ed Jul. 19, 1999.

### DESCRIPTION

The invention relates to loudspeakers and more particularly to digital loudspeakers. More particularly, but not exclusively, the invention relates to means for addressing an array of acoustical signal exciters, and to arrays of signal exciters per se in a loudspeaker.

Digital loudspeakers have been proposed in the past, see for example WO96/31086 of HOOLEY. In addition a low frequency loudspeaker has been demonstrated which comprises an array of small diaphragms each actuated by a mechanism resembling the individual pin actuators of a dot-matrix printer.

U.S. Pat. No. 5,517,570 describes a system with a plurality of loudspeaker pixels connected by means of a conventional data bus to a CAD (computer aided design) computer system.

WO 97 29550 A relates to a digital wireless speaker system for use in consumer audio applications.

WO 95 33357 A relates to a process for sound reproduction involving the provision of a digital audio signal comprising common sound data with individual addresses and associated control data for a plurality of sound reproduction devices.

It is among the objects of the invention to propose novel loudspeaker systems.

According to a first aspect of the invention there is provided a digital loudspeaker system comprising a plurality of loudspeaker elements, a transmitter for transmitting an information beam comprising units of digital information to the loudspeaker elements, each unit being intended for reproduction on at least one predetermined loudspeaker element, and selection means for causing each unit of digital information to be reproduced by the predetermined at least one loudspeaker element, characterised by a scanning head for directing the information beam to individual loudspeaker elements.

The information beam may be a beam of electromagnetic radiation, an electron beam or similar beam transmitted through the space between the transmitter and the loudspeaker elements. If required, the beam can be directed by means of mirrors, lenses or the like. The information beam may be a high data capacity microwave beam, in order that sufficient information can be carried.

The transmitter preferably transmits an information beam in parallel to each loudspeaker element. The selection means preferably includes an address decoder associated with each transducer for reading each information unit, determining if the information unit is intended for reproduction by the associated loudspeaker element, and causing information units intended for reproduction thereupon to be reproduced by the associated loudspeaker element

For manufacturing convenience, each address decoder and any additional circuitry may be formed as an integrated block, for example as a single integrated circuit.

The individual loudspeaker elements may be separately formed so that they can be independently arranged, for example to allow them to be arranged around the existing furniture in the room.

Alternatively, the elements can be formed in an integrated array. The array may be a synthesised array of the type described in WO99/08479.

The transmitter may be remote from the loudspeaker elements, so that the loudspeaker may be placed at a desired location without being constrained by the need to provide information-carrying cables between an amplifier and the loudspeaker.

The transmitter may also transmit power to the loudspeaker elements to drive the elements. The power may be provided from the transmitter used to transmit information, or a separate transmitter. This may allow a speaker with no cabling whatever, which simplifies placing the speakers in a room.

In an alternative approach in accordance with the invention the selection means may be a scanning means causing the information beam emitted by the transmitter to be directed to the predetermined loudspeaker element. The scanning may be performed by using a micromechanical mirror to deflect the beam; such mirrors are commercially available.

From another aspect the invention is a digital loudspeaker comprising an array of transducers for driving or simulating a loudspeaker diaphragm, and remote means for scanning and accessing the array to cause actuation of individual transducers.

The invention may provide non-contact methods of addressing and actuating an array of small transducers which together simulate a loudspeaker diaphragm to provide either coherent or diffuse acoustic radiation as desired.

The scanning means may comprise a scanning electron beam or a laser light beam, infra-red beam, radio wave emitter or the like. The scanning means may comprise a vector-scanning head for directing the actuating beam as desired.

The array may comprise a front face from which sound is emitted and shaped as desired, e.g. flat or curved, and a rear face adapted to be addressed by the transducer scanning means. Thus the rear face may be contoured as desired. Particularly where the loudspeaker is intended as a substantially flat panel, the scanning head may be disposed to one side of the array, e.g. at a corner or edge of the array, and the rear face of the array may be correspondingly shaped or sloped away from the scanning head to provide ready line-of-sight paths for the beam between the head and each of the transducers in the array. The transducers may be very small so as to form pixels in the array.

The transducers may be of electret or piezo electric material, or other bistable or tristable material, e.g. metal or plastics foil urged to change state by means of an electret or piezo device or may incorporate thin film transistors. Such transistors may be printed onto a sheet, film or foil of plastics material as desired. The transducers in the array may be very small so as to form pixels.

According to another arrangement, there is provided a loudspeaker, e.g. a digital loudspeaker, comprising a concentric array of loudspeaker drive devices.

The drive devices may be arranged in radial columns. The drive devices may be positioned closely together radially and/or concentrically. The drive devices may comprise panel diaphragms. The devices may comprise transducers driving the panel diaphragms. The diaphragms may be resonant devices, e.g. of the kind described in WO97/09842. Alternatively the drive devices may be pistonic. Alternatively again the drive devices may be digital, e.g. bistable or tristable devices. The loudspeaker devices tray comprise electromagnetic transducers, piezo devices, electret devices, electrostatic devices, biomechanical light actuated devices or the like.

The array may be flat or shaped, e.g. dished convexly or concavely or may be conical or frusto-conical. The array may resemble a horn e.g. with straight sides or flared. The array may resemble a cylinder which may have one or both ends open or closed.

If the array is not closely packed, or if curved, then there is a choice of geometrical distributions of the array. This can be used to choose suitable radiation properties.

Selection of individual elements using an array according to the invention can also allow some control of directivity, or a smoothing of the transfer function of the array.

The array may comprise a frame supporting the drive devices. The frame may resemble a spider's web in having a series of radial members and a series of generally concentric members joining adjacent radial members. The drive devices may be panels shaped to fit within the radial and concentric members of the frame. Thus the panels may be generally trapezoidal or segmental. The panel areas or sizes may be constant across the array or may increase from the centre to the outside of the array. The panel edges may be rigidly clamped in the frame. The panels may comprise acoustically active area(s) within the generally trapezoidal or segmental panel boundaries. The acoustically active area(s) may be embedded in the panels. The acoustically active area(s) may be supported in an acoustic suspension, e.g. a rigid, compliant or resilient suspension. The acoustically active area(s) may be of any desired shape, e.g. circular, elliptical, rectangular, square etc.

The drive units may be remotely actuated generally as described above. Thus the remote actuator may be positioned at the perimeter of the array or a plurality of actuators may be positioned at the perimeter to address individual drive units or groups of drive units. Alternatively the remote actuator may be disposed at the centre of the array. The actuator may comprise a rotating scanner device positioned at the centre of the array and having actuating means, e.g. an array of optical e.g. laser means, with one laser in the array dedicated to each concentric ring or row of drive units in the array. In this way the need for raster or vector scanning of the array is avoided and instead linear scanning is sufficient. The laser or other actuators may be rotationally and/or axially offset on the rotating scanner. The remote actuating means may be optical, electromagnetic, e.g. radio frequency, infra red, ultrasound or the like. Where the loudspeaker transducer devices are hard-wired, the arrangement may be such that each device is arranged to be operated at a different voltage, frequency, impedance or the like whereby the individual devices can be selectively actuated when the devices are wired together, e.g. in a grid.

One face of the array may be acoustically opaque. Each trapezoidal or segmental member or panel may comprise one or more sound emitting/acoustic signal generating devices. A loudspeaker may comprise a pair of dished arrays as described above to produce a hollow object which may, for example, be generally spherical in shape.

Miniature amplifiers may be embedded in each segmental or trapezoidal member/panel to energise the respective loudspeaker transducers.

The invention is diagrammatically illustrated, by way of example, in the accompanying drawings, in which:

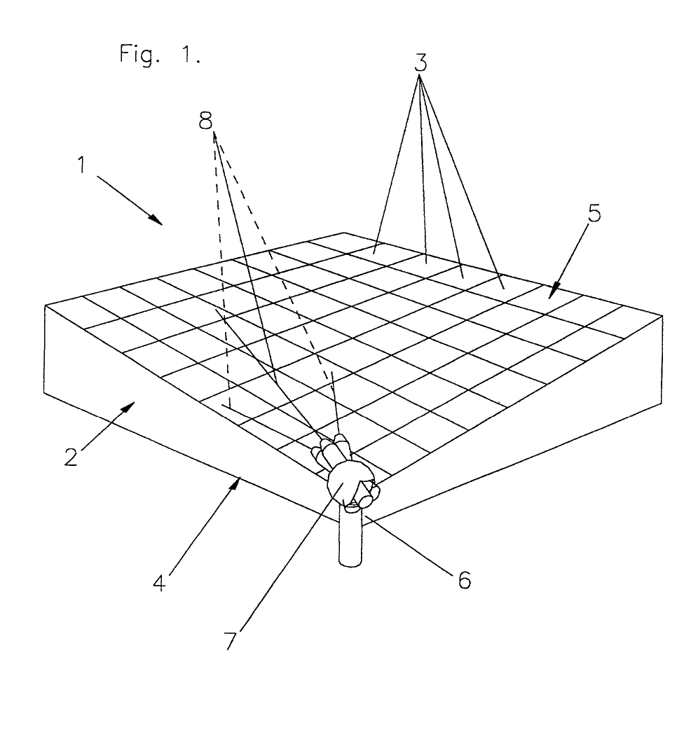

FIG. 1 is a perspective view showing a first implementation of substantially flat panel digital loudspeaker (1) showing an array (2) of loudspeaker transducers (3) having a planar front face (4) and a rear face (5) which is sloped or inclined away from a corner (6) at which is positioned a laser or like vector beam scanning head (7) to provide line-of-sight for a beam (8) to address the individual transducers (3) to activate the transducers as required to produce a desired acoustical output from the loudspeaker;

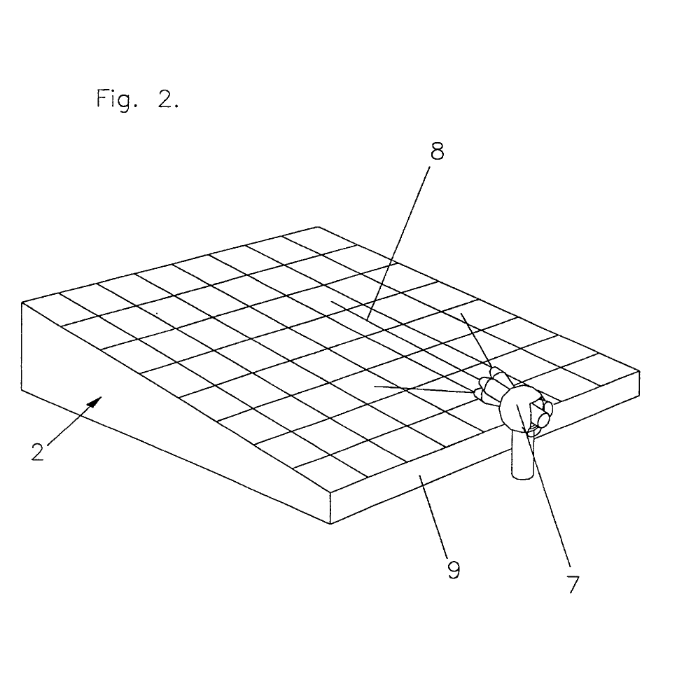

FIG. 2 shows an implementation of digital loudspeaker generally similar to that of FIG. 1, and in which the scanning head (7) is positioned along one side (9) of the array (2), which is thus sloped away from the side (9) to provide line-of-sight for the activating beam (8);

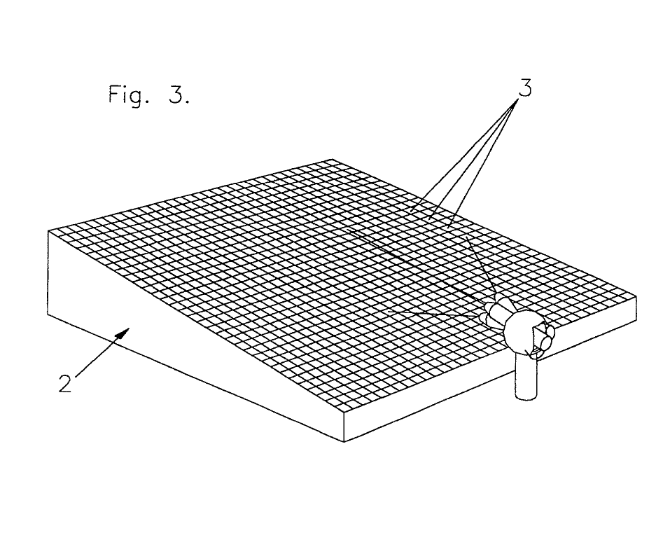

FIG. 3 shows an implementation of digital loudspeaker generally similar to that of FIG. 2, and in which the transducers (3) in the array (2) are very small so as to form pixels;

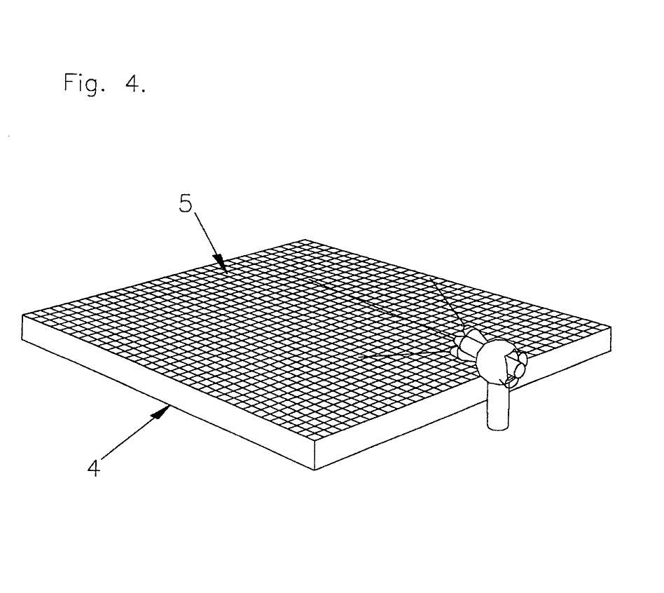

FIG. 4 shows a digital loudspeaker similar to that of FIG. 3 and in which the rear face (5) of the screen is not inclined with respect to the front face (4);

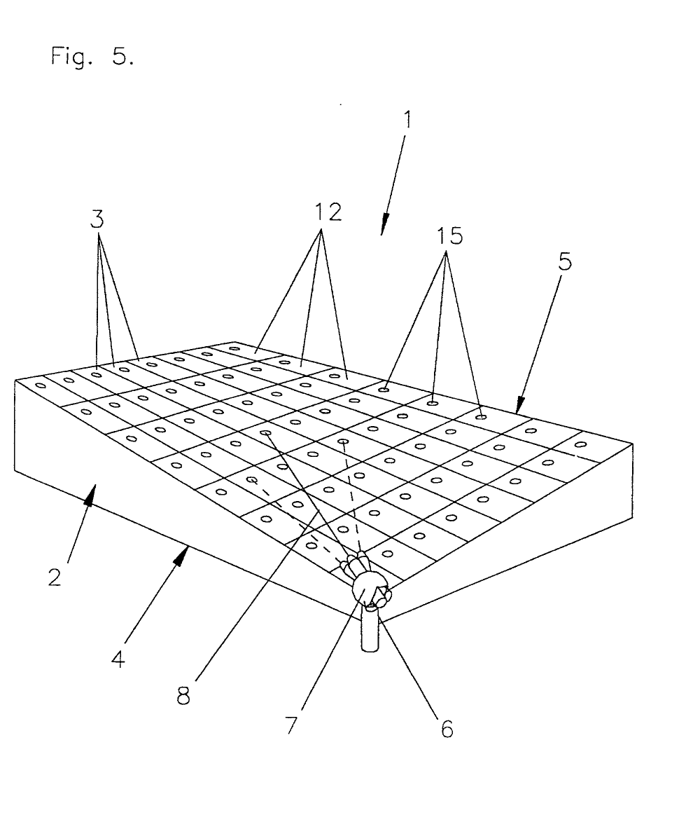

FIG. 5 is a perspective view, generally similar to that of FIG. 1, of another embodiment of digital loudspeaker in which the array (2) is generally rectangular as compared to the generally square array of FIG. 1. The aspect ratio of the rectangular array may be in accordance with the preferred aspect ratios set out in International application WO97/09842 of New Transducers Limited. Also in accordance with the teachings in WO97/09842, each transducer (3) in the array (2) may comprise a resonant distributed mode loudspeaker panel or diaphragm (12) having an exciter (15) thereon to apply bending wave vibration thereto to excite resonances in the panel to provide an acoustic output. The beam (8) from the scanning head is arranged to activate each vibration exciter (15) as required;

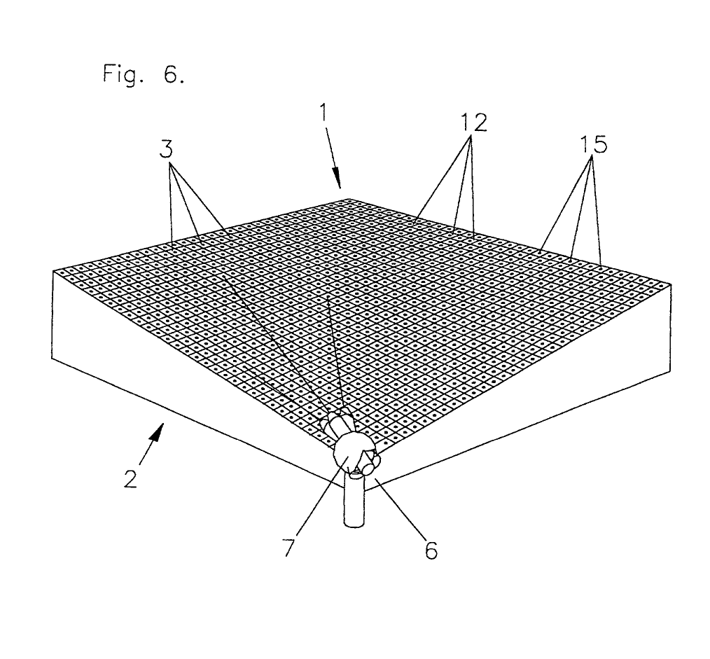

FIG. 6 is a perspective view of yet another embodiment of digital loudspeaker very similar to that of FIG. 5 and comprising an array (2) having a relatively large number of transducers each of which is very small;

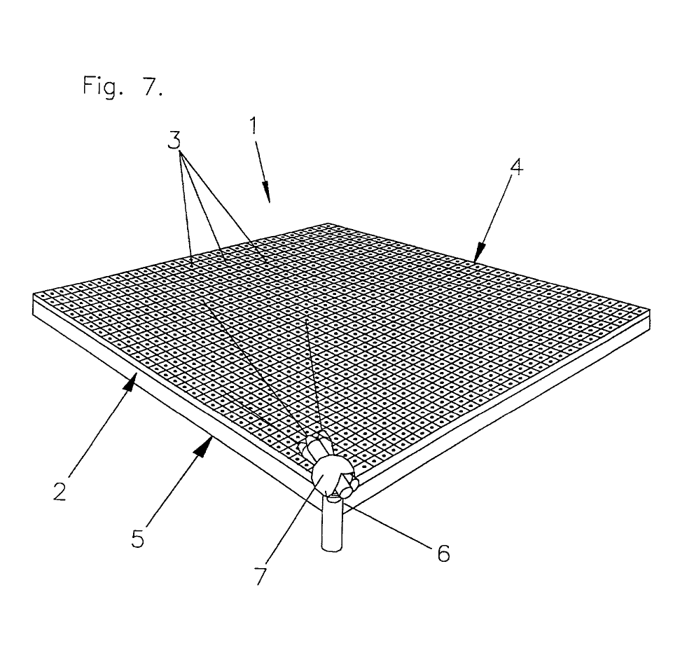

FIG. 7 is a perspective view of another embodiment of digital loudspeaker generally similar to that of FIG. 6 and in which the array is flat in the sense that the front and rear faces (4,5) of the array (2) are parallel;

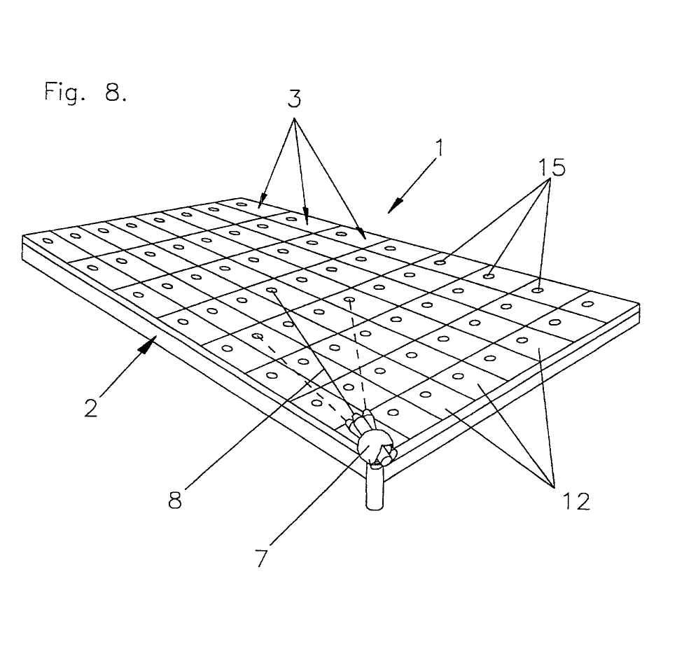

FIG. 8 is a perspective view of a further embodiment of digital loudspeaker similar to that of FIG. 7 and in which the transducers (3) in the array (2) are relatively large as compared to those of FIG. 7. In this embodiment each transducer (3) is a generally rectangular resonant panel or diaphragm (12) having a vibration exciter (15) mounted thereon, e.g. as taught in WO97/09842 to apply bending wave energy thereto to excite panel resonances to produce an acoustic output when the exciter is activated by the activating beam (8) from the scanning head (7). In this embodiment the loudspeaker array is also rectangular e.g. in accordance with the teachings in WO97/09842;

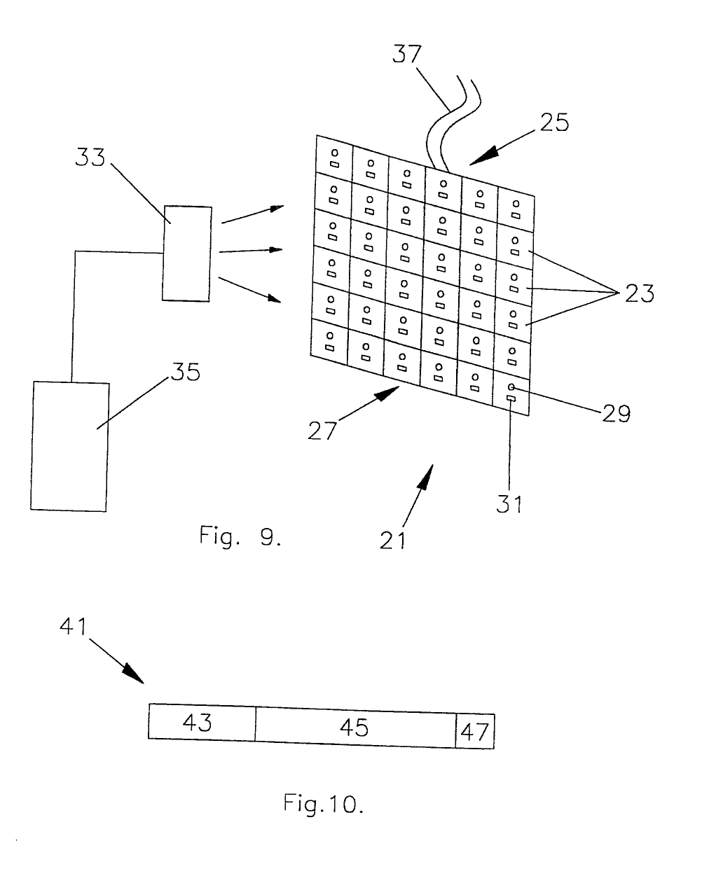

FIG. 9 is a diagram of a presently preferred embodiment of the invention.

An array 21 of loudspeaker elements 23 has a front face 25 and a rear face 27. Each element has a transducer 29 and a circuit 31 mounted on the rear.

A transmitter 33 transmits a microwave beam 34 to the circuit 31 in parallel. A source 35 supplies digital information, divided into units. Each unit is intended for reproduction on one or more loudspeaker elements 23. The circuit 31 of each loudspeaker element 23 selects the correct units intended for reproduction on that loudspeaker element 23 and transmits an analogue signal to the transducer 29 to cause the transducer element 23 to emit sound in accordance with the information transmitted to that loudspeaker element 23.

Power is transmitted to the array 21 by power leads 37.

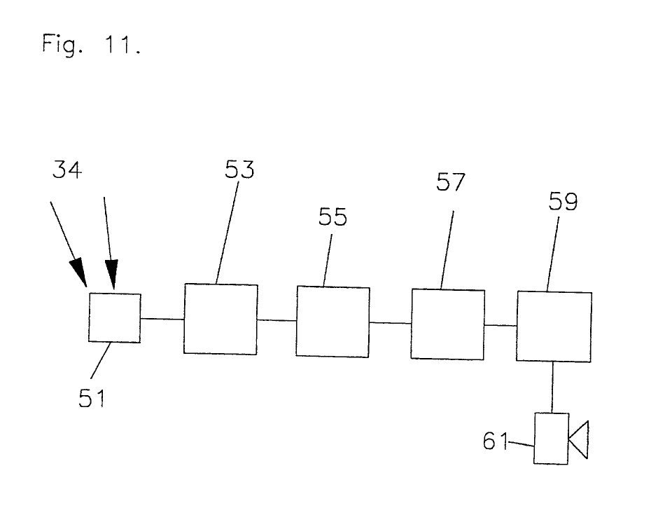

FIG. 10 illustrates an information unit 41. Each unit has a header 43, a body 45 and an end 47. The header 43 contains an address code indicating the loudspeaker element or elements intended. The body 45 includes the sound information required to be emitted by the intended loudspeaker element 23.

FIG. 11 is a block diagram of the circuit 31 provided at each loudspeaker element of the loudspeaker shown in FIG. 9. A receiver 51 receives the signal radiated by the transmitter and transmits it to an address decoder 53. Signals intended for the loudspeaker element are passed on to a digital signal processor 55, a decoder 57 for performing the digital to analogue conversion, an amplifier 59 and a transducer 61 for mechanically driving the loudspeaker element.

Some or all of these elements may be formed as an integrated circuit. It is also possible to provide a digital transducer to combine the functions of digital to analogue conversion and the transducer itself.

The receiver 51 may be a photodiode, a small microwave antenna or similar depending on the nature of the transmitted beam. The small aerial may be a loop formed by a thick or thin film process.

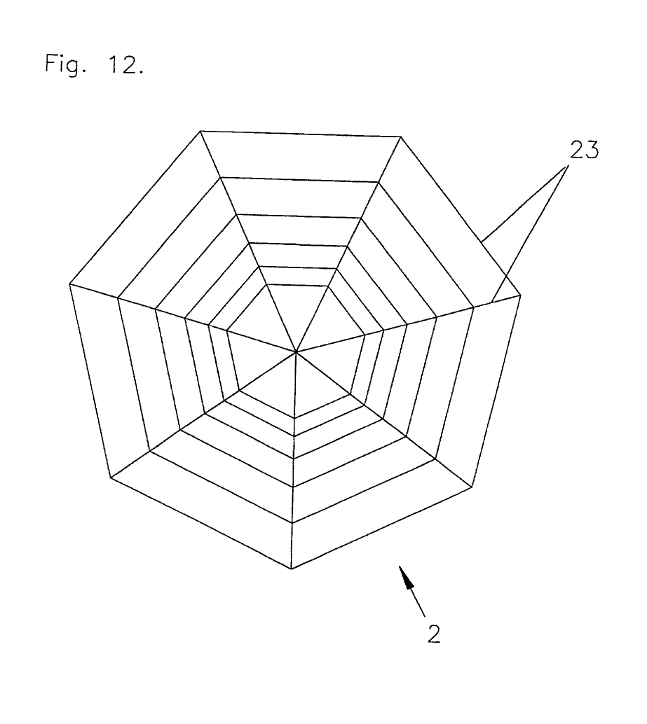

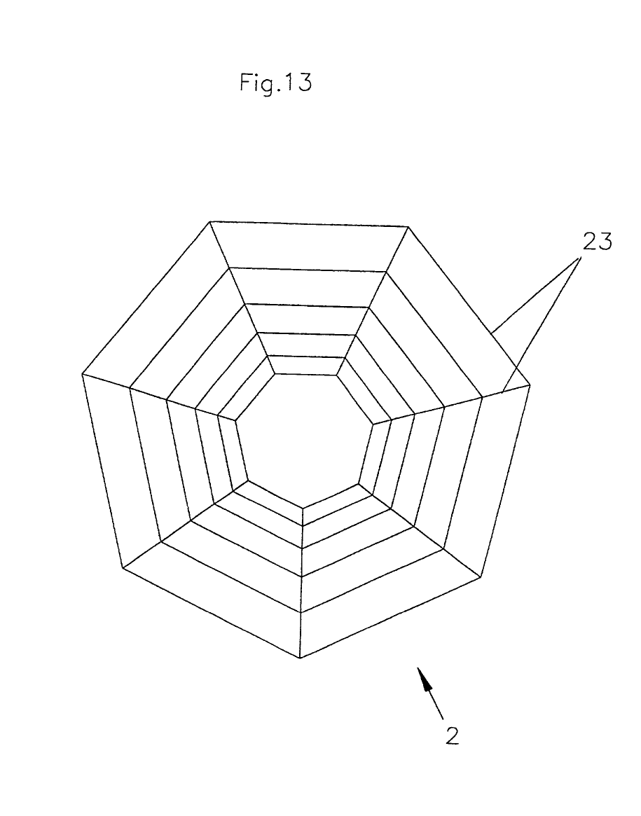

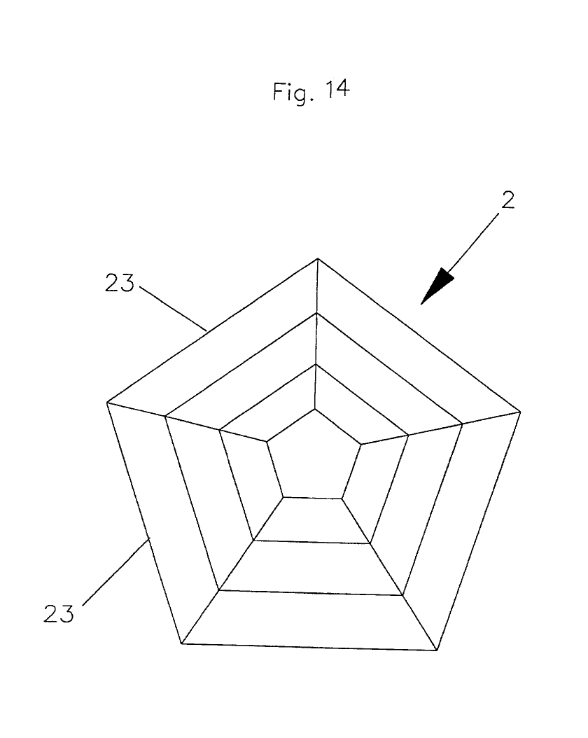

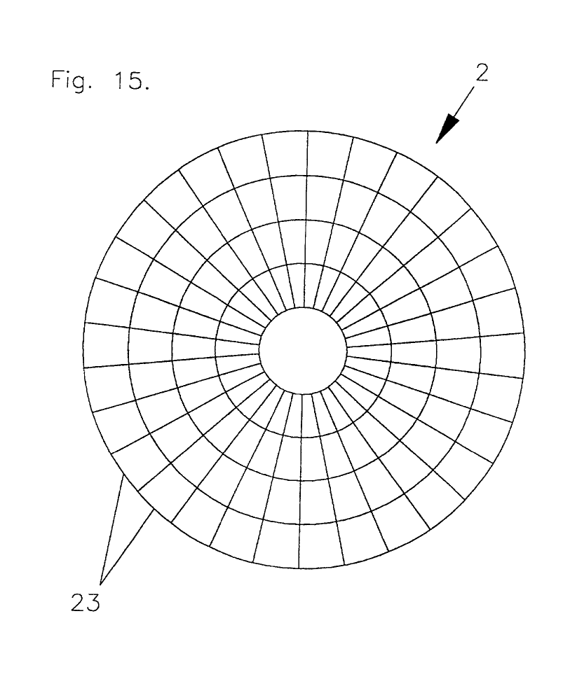

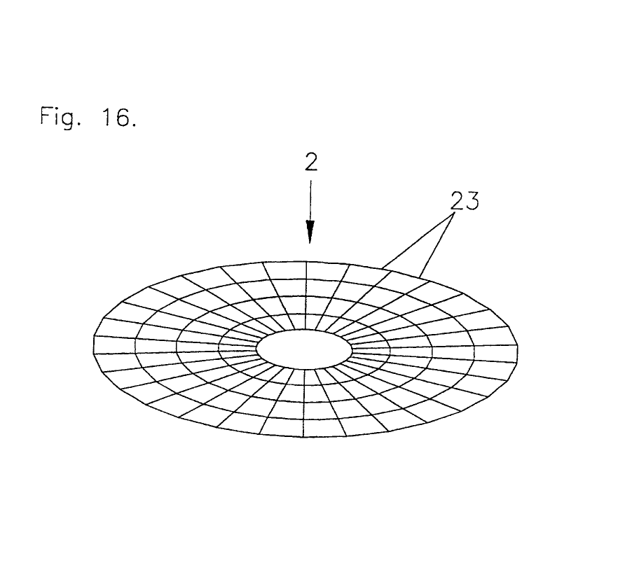

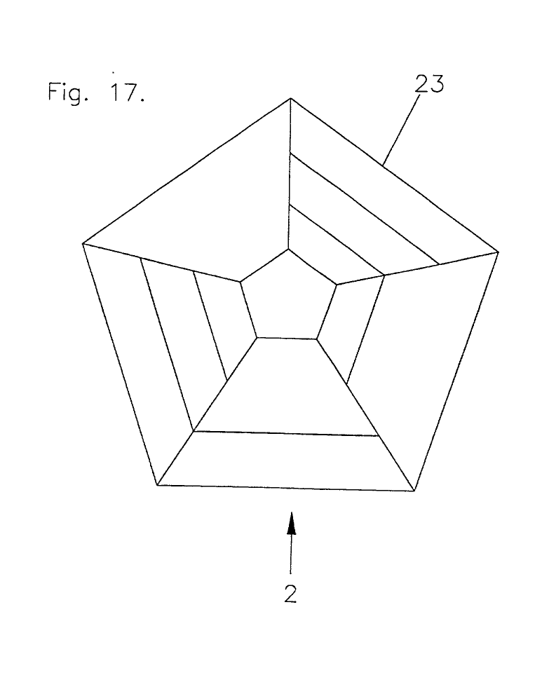

FIGS. 12 to 17 of the drawings show various embodiments of array based, at least to some extent, on a spider's web configuration and comprising concentric and radial arrangements of segmental or trapezoidal-shaped facets or panels each of which may be a panel-form loudspeaker drive unit or may carry a loudspeaker drive unit. The arrays may vary in shape from generally circular as shown in FIG. 15, to elliptical as shown in FIG. 16 to polygonal as shown in FIGS. 12 to 14 and 17. The panels or facets may extend to the centre of the array as shown in FIG. 12 or the centre may be open as shown, for example, in FIGS. 13 to 17. Some facets or panels may be omitted to leave an opening and/or some panels or facets may be larger as indicated in FIG. 17;

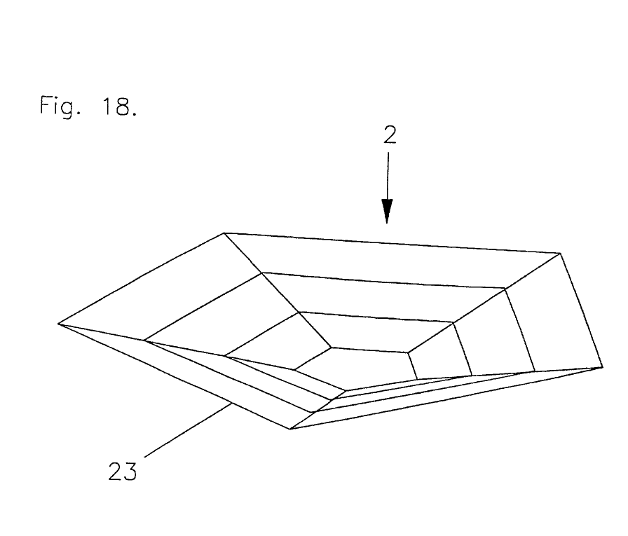

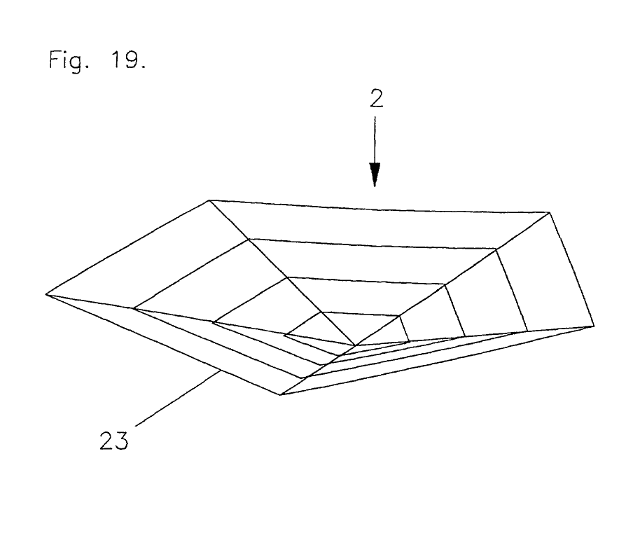

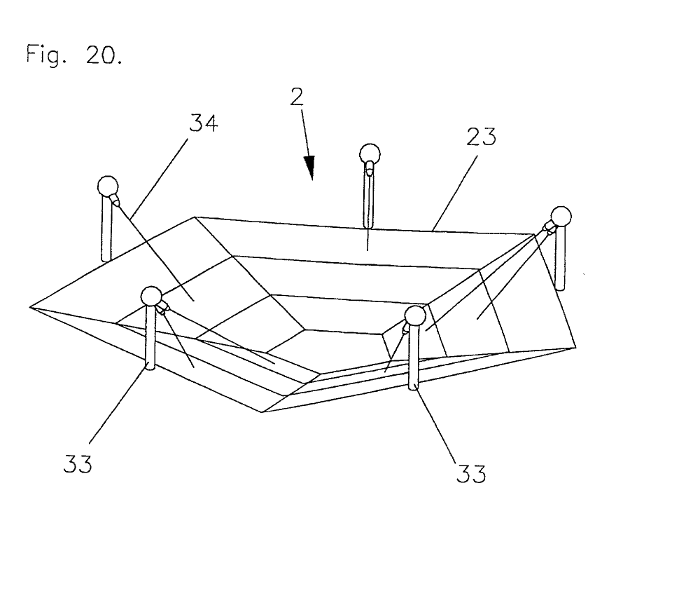

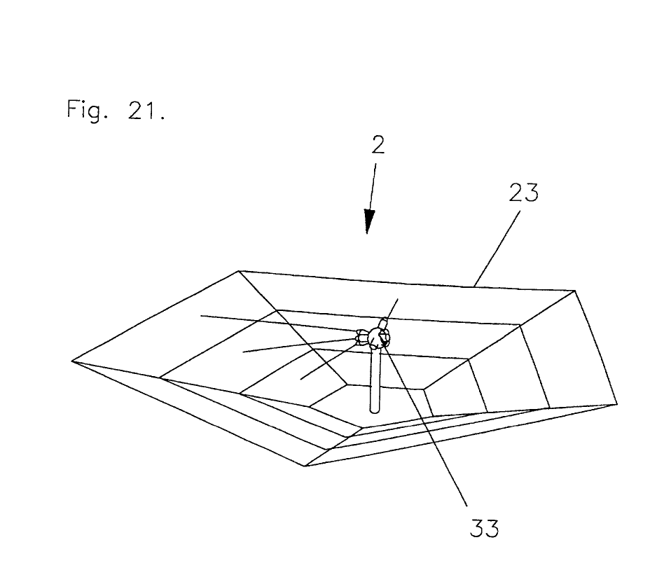

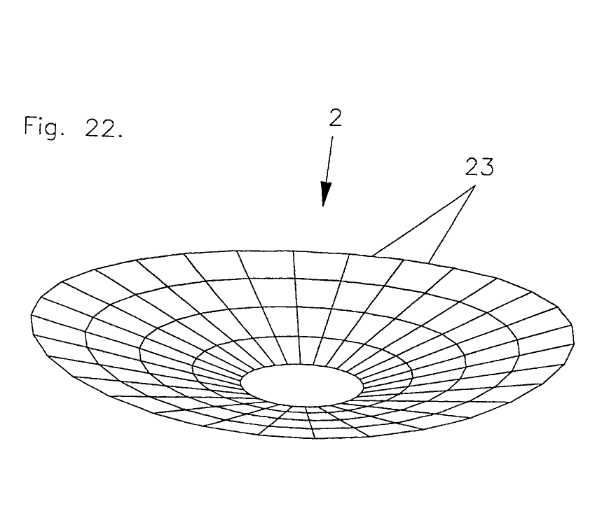

FIGS. 18 to 22 illustrate various arrays generally similar to those of FIGS. 12 to 17, but which unlike the flat arrays of FIGS. 12 to 17 are convexly or concavely dished. As shown in FIG. 20, a series of scanners may be positioned round the perimeter of the array to address and activate respective radial rows or columns of transducers incorporated in the various facets or panels in the array. Alternatively as shown in FIG. 21, a single vector scanner may be positioned at the centre of the array of transducers;

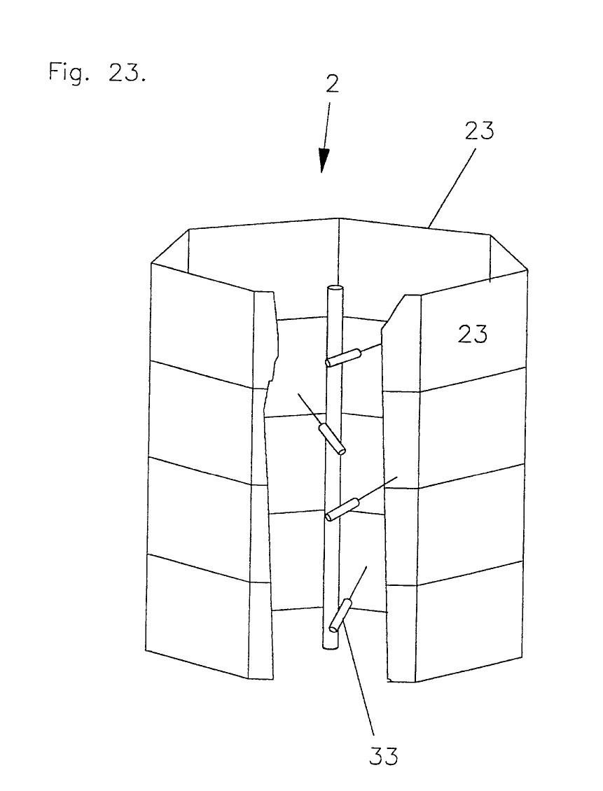

FIG. 23 shows a generally cylindrical array of facets or panels scanned by a rotating scanner having an axis of rotation on the central axis of the array and having a plurality of scanner heads each of which is radially and axially offset from the other heads and each adapted to scan one concentric ring of the panels or facets to active the respective transducers as required;

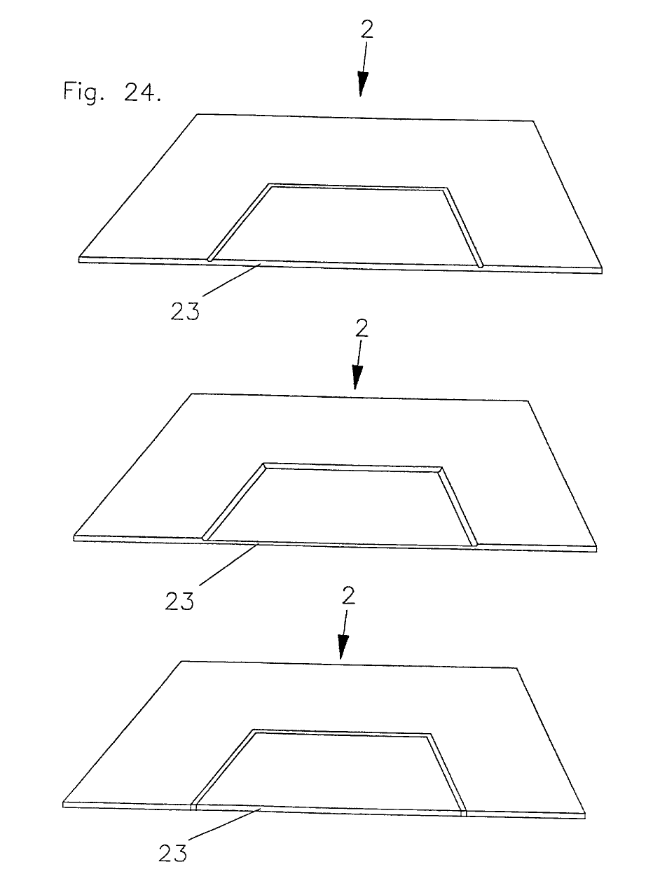

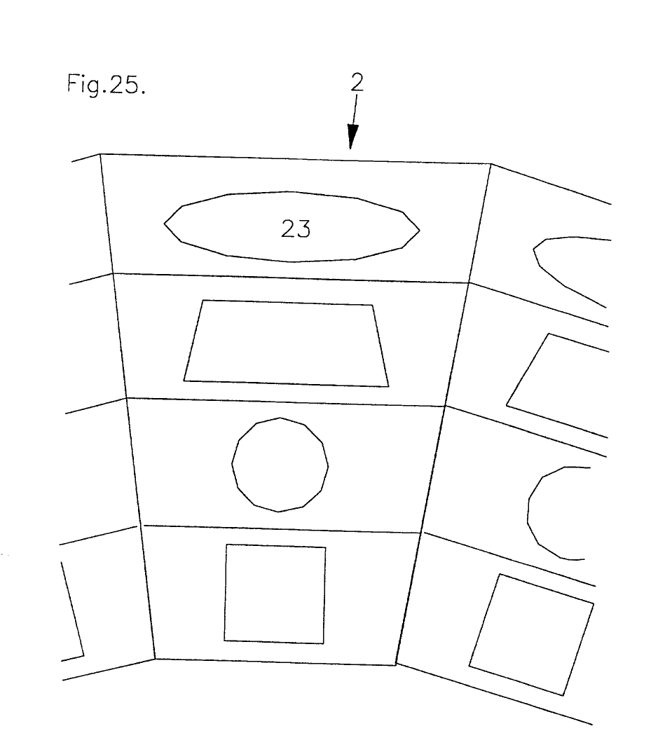

FIGS. 24 and 25 illustrate that the facets or panels may be sub-divided whereby, for example, only part of each facet or panel is acoustically active. The shapes of the acoustically active areas may be defined as desired, e.g. trapezoidal, circular, square, elliptical, rectangular etc;

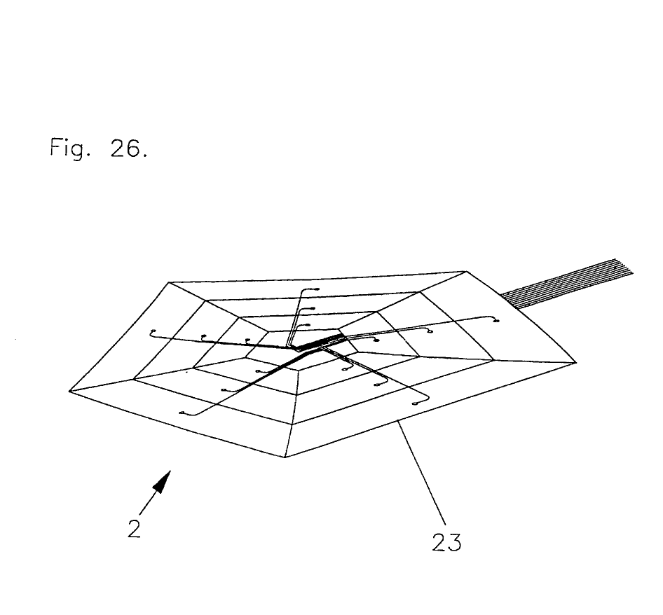

FIG. 26 shows an array in which the transducers are addressed by hard wiring, e.g. electrical conductors or optical fibres;

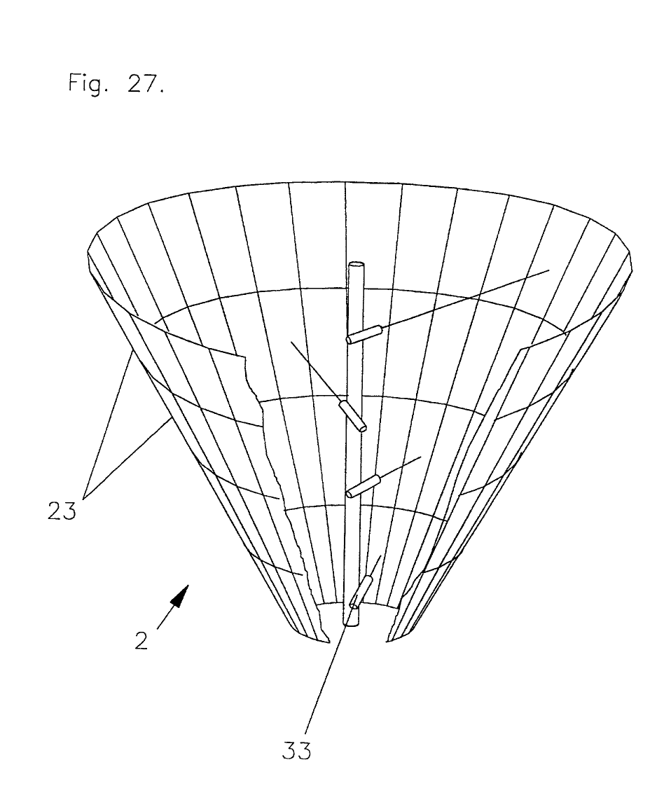

FIG. 27 shows an array which is generally similar to that of FIG. 23 but shows a generally conical array of loudspeaker panels or facets addressed and activated by a rotating scanning head positioned on the axis of the cone;

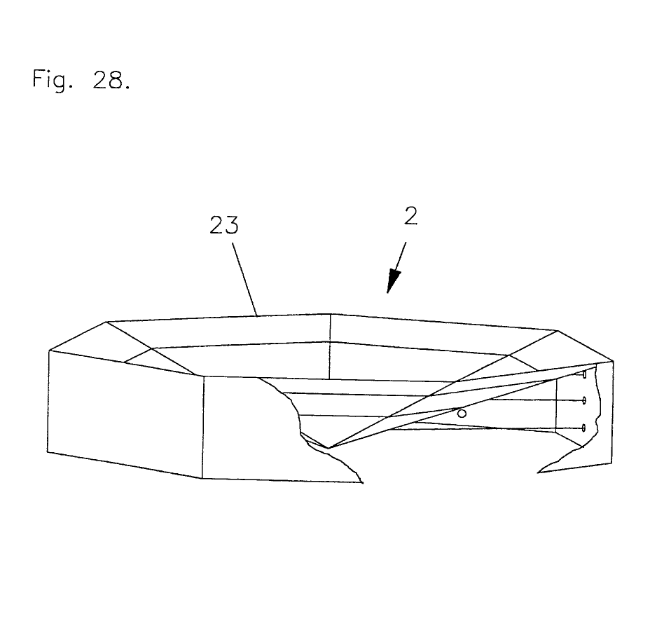

FIG. 28 shows a dished array addressed from its convex underside by remote scanning means disposed in a surrounding peripheral rim and having a plurality of beam projectors, respective ones of which are dedicated to each facet or panel in the array;

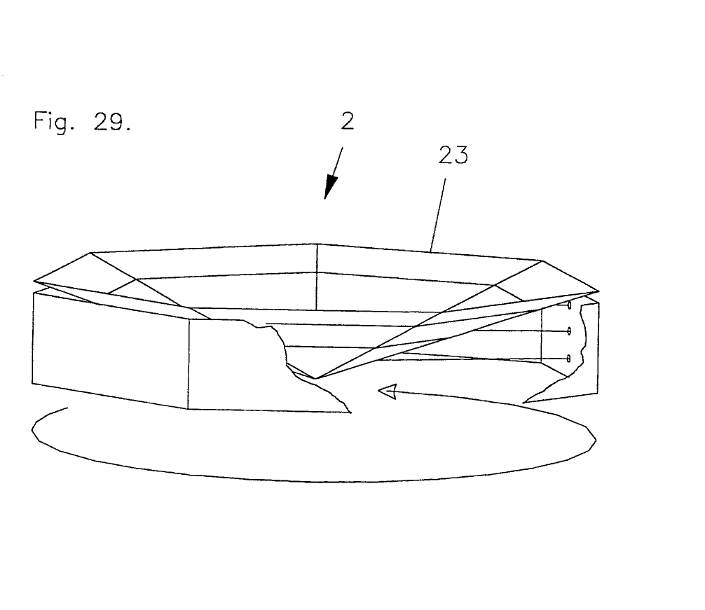

FIG. 29 shows an arrangement generally similar to that of FIG. 28 and in which the peripheral rim is arranged to rotate whereby the scanning beams can each address respective concentric rings of panels or facets in the array;

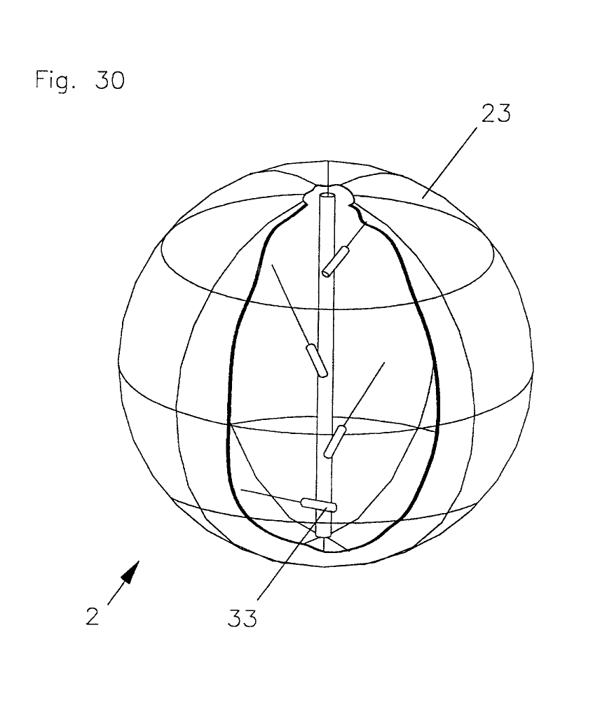

FIG. 30 shows an array which is generally spherical, formed perhaps by assembling together two dished arrays and addressed by a rotating scanning device arranged to extend along the polar axis of the array and of the general kind described with reference to FIG. 23 above;

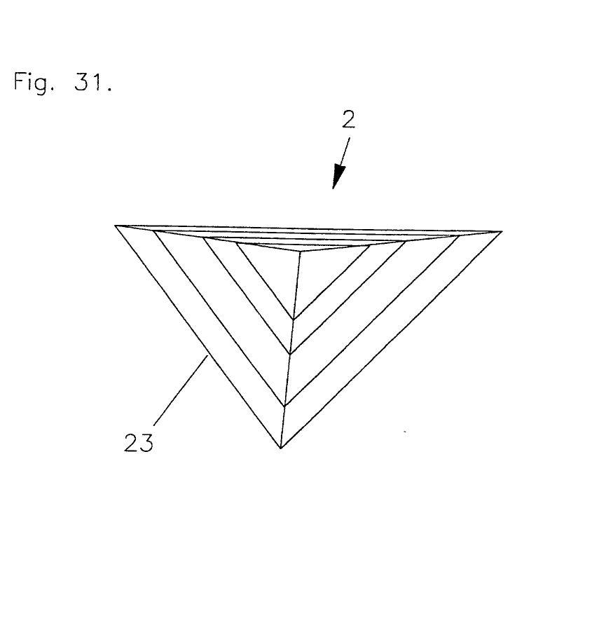

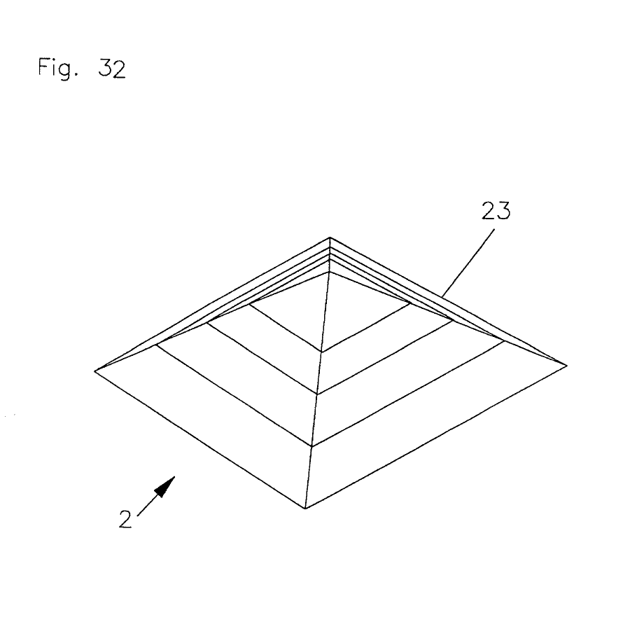

FIGS. 31 and 32 show pyramidal arrays which are respectively three and four sided, and

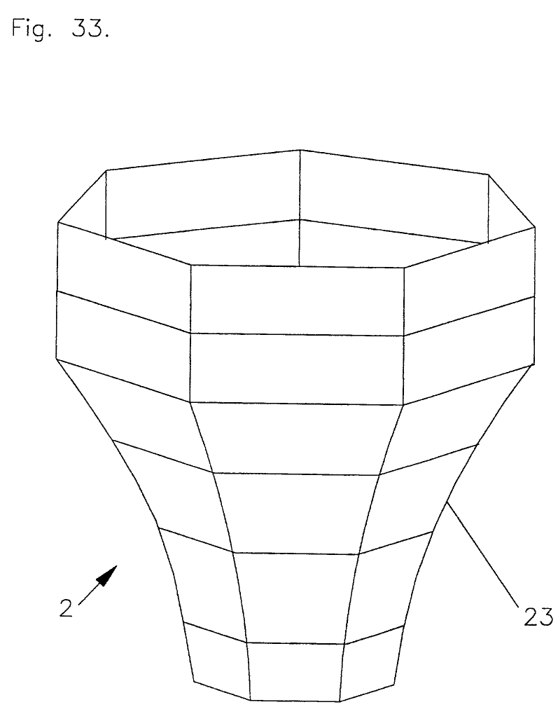

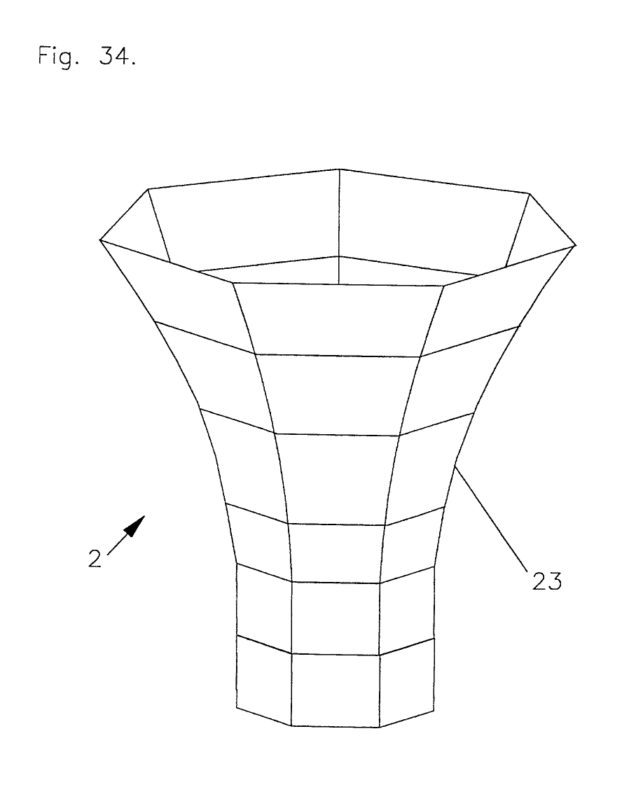

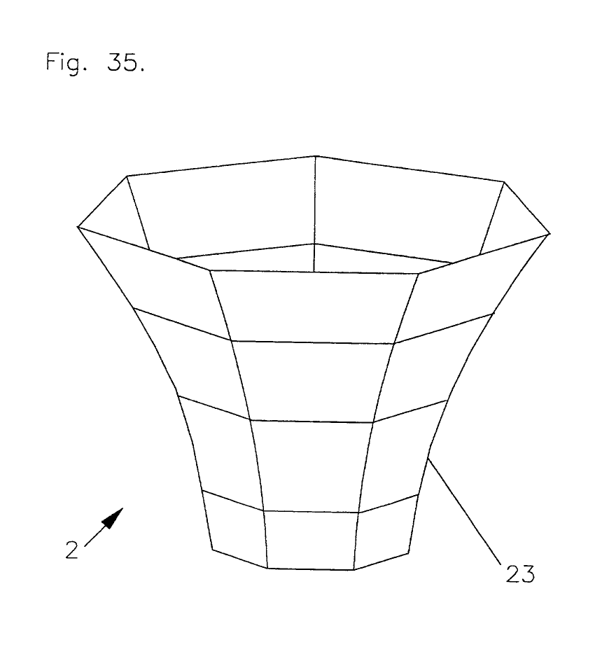

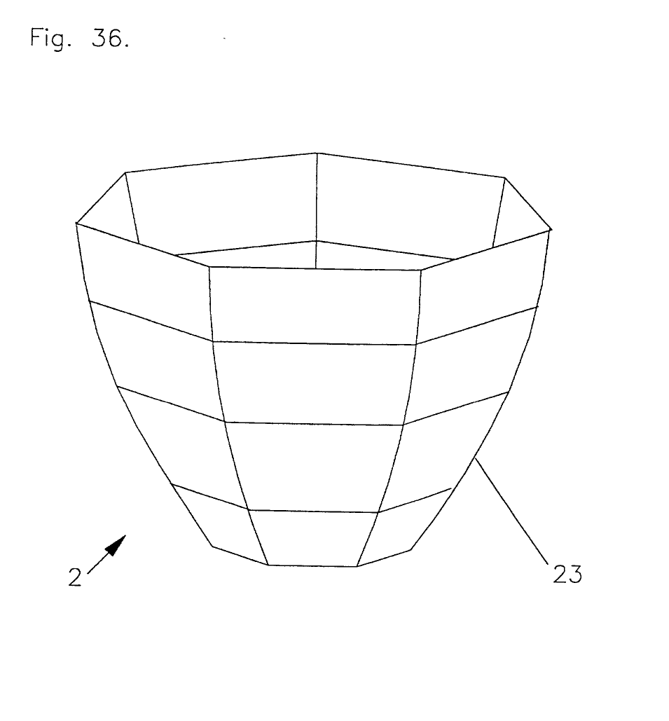

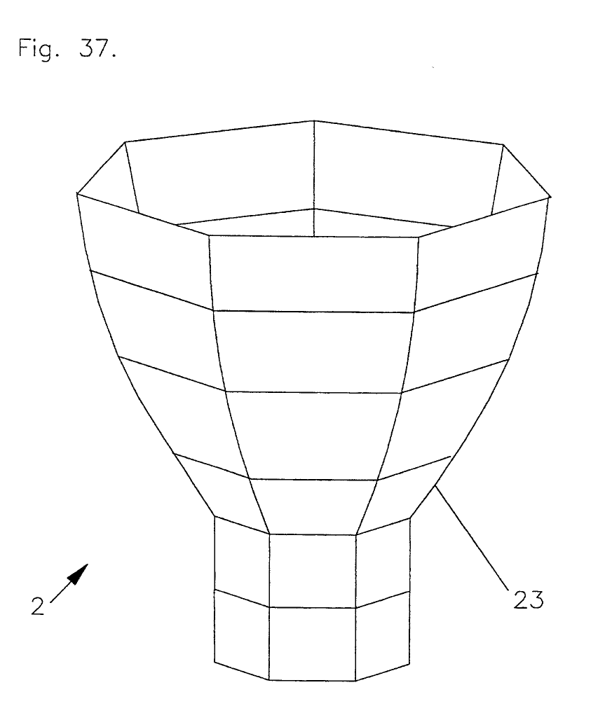

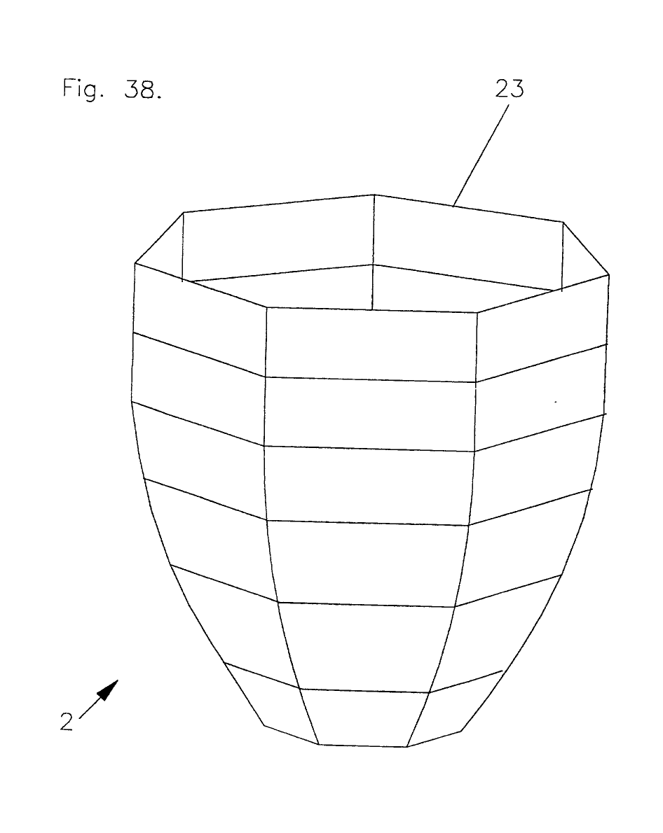

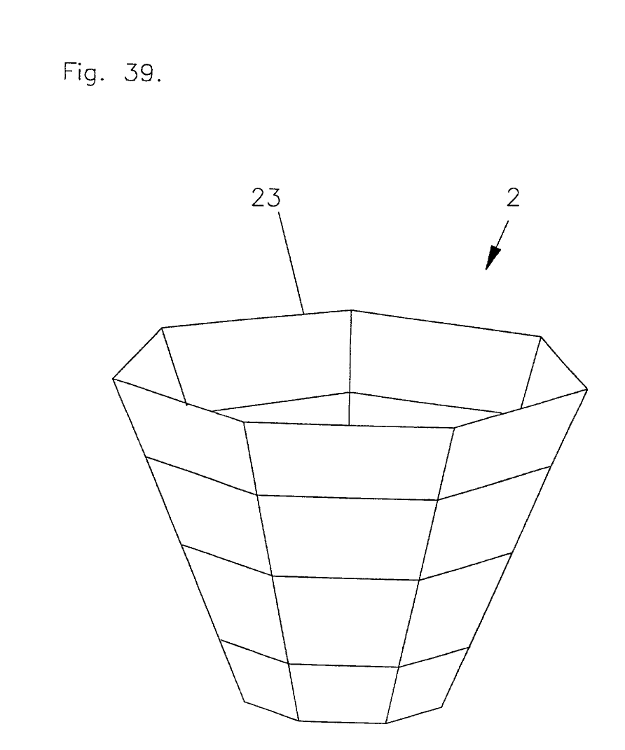

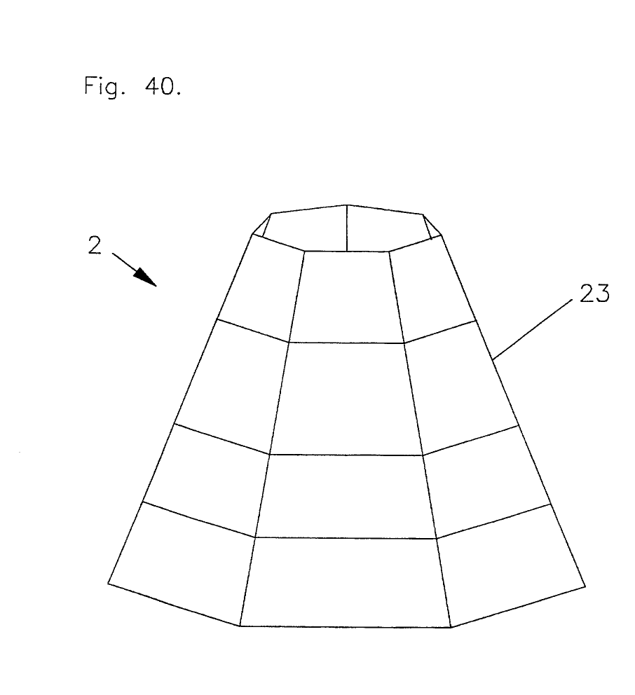

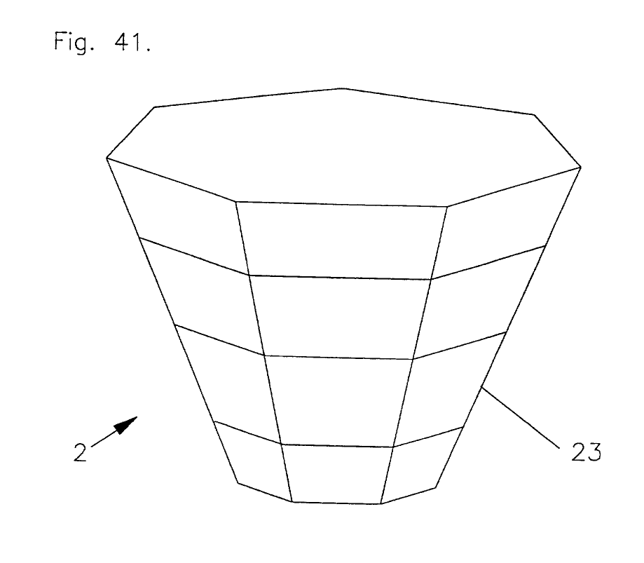

FIGS. 33 to 41 show various alternative shapes of multi-faceted loudspeaker array all based generally on a basic spider's web shape.

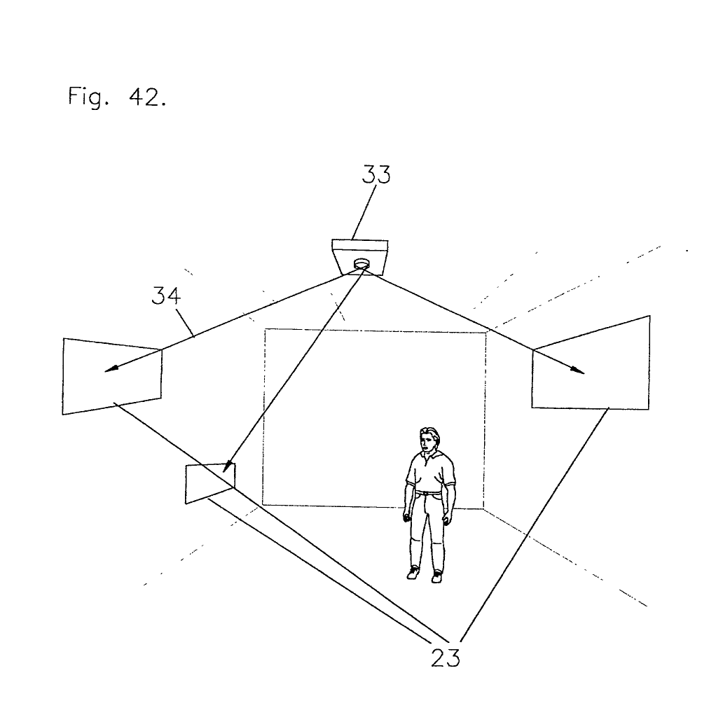

FIG. 42 shows a loudspeaker system according to the invention having a number of separate wall-mounted speakers 23 with no wiring. The speakers are mounted at various locations around a room. The power and information is transmitted to the speakers from the transmitter 33. The sound produced is completely at the control of the designer; for special effects selected speakers can be switched on and off as desired.

The invention thus provides several implementations of digital loudspeaker.

1. A digital loudspeaker system comprising
a plurality of loudspeaker elements (23),
a transmitter (33) for transmitting an information beam (34) comprising units of digital information to the loudspeaker elements, each unit being intended for reproduction on at least one predetermined loudspeaker element, and
selection means (31) for causing each unit of digital information to be reproduced by the predetermined at least one loudspeaker element (23), characterized by
a scanning head (7) for directing the information beam (34) to individual loudspeaker elements (23).

2. A loudspeaker system according to claim 1 wherein the transmitter (33) transmits an information beam of electromagnetic radiation.

3. A loudspeaker system according to claim 2 wherein the information beam (34) is a microwave beam.

4. A loudspeaker system according to claim 1 wherein the transmitter (33) transmits an information beam (34) to each loudspeaker element in parallel, and the selection means includes an address decoder (53) associated with each loudspeaker element (23) for reading each information unit, determining if the information unit is intended for reproduction on the associated loudspeaker element (23), and causing information units intended for reproduction thereupon to be reproduced by the associated loudspeaker element.

5. A loudspeaker system according to claim 1 wherein each loudspeaker element comprises a receiver (51).

6. A loudspeaker system according to claim 1 wherein the transmitter (33) transmits power to the loudspeaker elements (23) to drive the elements.

7. A loudspeaker system according to claim 2 wherein the selection means is a scanning means causing the information beam (34) emitted by the transmitter (33) to be directed to the at least one predetermined loudspeaker element(23).

8. A loudspeaker system according to claim 1 wherein the loudspeaker elements are (23) separate from one another.

9. A loudspeaker system according to claim 1 in which the loudspeaker elements (23) are formed as an array (21).

10. A loudspeaker system according to claim 9 in which the array (21) has a front surface (25) from which sound is emitted and a rear surface (27) on which circuits (31) are mounted.

11. A loudspeaker system according to claim 1 in which the loudspeaker elements (23) are distributed mode loudspeaker elements.
